(19) United States
(12) Patent Application Publication
(10) Pub. No.: US 2007/0036419 A1
(43) Pub. Date: Feb. 15, 2007

(54) System and method for interactive definition of image field of view in digital radiography

(75) Inventors: Kadri Nizar Jabri, Waukesha, WI (US); Ramalingam Rathinasabapathy, Bangalore (IN)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/200,699

(22) Filed: Aug. 9, 2005

(51) Int. Cl. G06K 9/00

(52) U.S. Cl. 382/132

(57) ABSTRACT

Certain embodiments provide a system and method for improved adjustment of a field of view for an image. The system includes an image processor configured to process raw image data to generate a processed image and a user interface configured to allow a user to adjust the field of view for the processed image. The image processor automatically determines a field of view for the raw image data for use in generating the processed image. The user interface may be used to select a series of points/vertices and/or a boundary in an image to adjust the field of view, for example. The image processor may re-process the processed image using the adjusted field of view, for example. The image may be cropped based on the adjusted field of view. The system may also include a storage device for storing the processed image with the adjusted field of view.

### BACKGROUND OF THE INVENTION

The present invention generally relates to definition of an image field of view. In particular, the present invention relates to a system and method for interactive definition of an image field of view in digital radiography.

Digital imaging systems may be used to capture images to assist a doctor in making an accurate diagnosis. Digital radiography imaging systems typically include a source and a detector. Energy, such as x-rays, produced by the source travel through an object to be imaged and are detected by the detector. An associated control system obtains image data from the detector and prepares a corresponding diagnostic image on a display.

The detector may be an amorphous silicon flat panel detector, for example. Amorphous silicon is a type of silicon that is not crystalline in structure. Image pixels are formed from amorphous silicon photodiodes connected to switches on the flat panel. A scintillator is placed in front of the flat panel detector. For example, the scintillator receives x-rays from an x-ray source and emits light in response to the x-rays absorbed. The light activates the photodiodes in the amorphous silicon flat panel detector. Readout electronics obtain pixel data from the photodiodes through data lines (columns) and scan lines (rows). Images may be formed from the pixel data. Images may be displayed in real time. Flat panel detectors may offer more detailed images than image intensifiers. Flat panel detectors may allow faster image acquisition than image intensifiers.

A solid state flat panel detector typically includes an array of picture elements (pixels) composed of Field Effect Transistors (FETs) and photodiodes. The FETs serve as switches, and the photodiodes are light detectors. The array of FETs and photodiodes may be composed of amorphous silicon. A compound such as Cesium Iodide (CsI) is deposited over the amorphous silicon. CsI absorbs x-rays and converts the x-rays to light. The light is then detected by the photodiodes. The photodiode acts as a capacitor and stores charge.

Initialization of the detector occurs prior to an exposure. During an initialization of the detector, the detector is “scrubbed” prior to an exposure. During scrubbing, each photodiode is reverse biased and charged to a known voltage. The detector is then exposed to x-rays which are absorbed by the CsI deposited on the detector. Light that is emitted by the CsI in proportion to x-ray flux causes the affected photodiodes to conduct, partially discharging the photodiode. After the conclusion of the x-ray exposure, a voltage on each photodiode is restored to an initial voltage. An amount of charge to restore the initial voltage on each affected photodiode is measured. The measured amount of charge becomes a measure of an x-ray dose integrated by a pixel during the length of the exposure.

The detector is read or scrubbed according to the array structure. That is, the detector is read on a scan line by scan line basis. A FET switch associated with each photodiode is used to control reading of photodiodes on a given scan line. Reading is performed whenever an image produced by the detector includes data, such as exposure data and/or offset data. Scrubbing occurs when data is to be discarded from the detector rather than stored or used to generate an image. Scrubbing is performed to maintain proper bias on the photodiodes during idle periods. Scrubbing may also be used to reduce effects of lag or incomplete charge restoration of the photodiodes, for example.

Scrubbing restores charge to the photodiodes but the charge may not be measured. If the data is measured during scrubbing, the data may simply be discarded.

Switching elements in a solid state detector minimize a number of electrical contacts made to the detector. If no switching elements are present, at least one contact for each pixel is present in on the detector. Lack of switching elements may make the production of complex detectors prohibitive. Switching elements reduce the number of contacts to no more than the number of pixels along the perimeter of the detector array. The pixels in the interior of the array are “ganged” together along each axis of the detector array. An entire row of the array is controlled simultaneously when the scan line attached to the gates of the FETs of pixels on that row is activated. Each of the pixels in the row is connected to a separate data line through a switch. The switch is used by read out electronics to restore charge to the photodiode. As each row is activated, all of the pixels in the row have the charge restored to the respective photodiodes simultaneously by the read out electronics over the individual data lines. Each data line typically has a dedicated read out channel associated with the data line.

Additionally, the detector electronics may be constructed in basic building blocks to provide modularity and ease of reconfiguration. Scan drivers, for example, may be modularized into a small assembly that incorporates drivers for 256 scan lines, for example. The read out channels may be modularized into a small assembly that would read and convert the signals from, for example, 256 data lines. The size, shape, architecture and pixel size of various solid state detectors applied to various imaging systems determine the arrangement and number of scan modules and data modules to be used.

A control board is used to read the detector. Programmable firmware may be used to adapt programmable control features of the control board for a particular detector. Additionally, a reference and regulation board (RRB) may be used with a detector to generate noise-sensitive supply and reference voltages (including a dynamic conversion reference) used by the scan and data modules to read data. The RRB also distributes control signals generated by the control board to the modules and collects data returned by the data modules. Typically, the RRB is designed specifically for a particular detector. An interface between the control board and the RRB may be implemented as a standard interface such that signals to different detectors are in a similar format.

In digital radiography, an image signal is read from an entire detector area, regardless of an exposed field-of-view (FOV) determined by collimation. For example, an image read from a digital detector may be 2k×2k pixels in size, but only a fraction of the image area is actually exposed and contains clinically useful information (see, e.g., FIG. 1). Processing functions may be applied to image data based on the FOV.

Radiography systems typically do one of the following with the digital image that is read from a flat-panel detector or from a Computed Radiography (CR) plate:

1. Image size is maintained and the entire image is stored. The stored image size (in terms of pixels) is the same as the detector size.

2. The exposed FOV is estimated based on positioner feedback (hardware), and the image is cropped to the rectangular area bounding the exposed FOV. The stored image size (in terms of pixels) is less than the detector size.

3. The exposed FOV is estimated based on image content (e.g. using software), and the image is cropped to the rectangular area bounding the exposed FOV. The stored image size (measured in terms of pixels, for example) is less than the detector size.

For solution (1), a significant amount of storage capacity may be wasted, even if image compression schemes are used. For solutions (2) and (3), an incorrect or inaccurate determination of the exposed FOV might lead to an irrecoverable loss of image diagnostic information. Such issues can occur due to hardware malfunctions, software errors, or system calibration errors. Even if the lost image information is not critical for diagnosis, an incorrect or inaccurate FOV may adversely affect image processing and display, and in turn degrade the diagnostic quality of an image.

Therefore, there is a need for an improved method and system for FOV definition. There is a need for a system and method by which a user interactively confirms or corrects an automatically determined FOV before an image is permanently cropped and stored.

### BRIEF SUMMARY OF THE INVENTION

Certain embodiments of the present invention provide an improved system and method for improved definition of a field of view for a digital radiography image. Certain embodiments provide a method including retrieving image data for an image, automatically determining a field of view for the image, manually adjusting the field of view, confirming the adjusted field of view, and storing the image based on the adjusted field of view. The field of view may be adjusted using a user interface, such as a graphical user interface, for example. The field of view may be adjusted using a variety of techniques including selecting a series of points or vertices on the image, selecting a boundary to define the field of view, etc. The method may further include processing image data with information extracted from the automatically determined field of view and/or the adjusted field of view, for example. The method may also include cropping the image based on the adjusted field of view.

Certain embodiments provide a system for improved adjustment of a field of view for an image. The system includes an image processor configured to process raw image data to generate a processed image and a user interface configured to allow a user to adjust the field of view for the processed image. The image processor automatically determines a field of view for the raw image data for use in generating the processed image. The user interface may be used to select a series of points/vertices and/or a boundary in an image to adjust the field of view, for example. The image processor crops the processed image based on the adjusted field of view. The image processor may re-process the processed image using the adjusted field of view, for example. The system may also include a storage device for storing the processed image with the adjusted field of view. The system may also crop the processed image such that only image data inside the rectangle bounding the adjusted field of view is stored. In an embodiment, the storage device stores the processed image with the adjusted field of view in association with the raw image.

Certain embodiments provide a computer-readable storage medium including a set of instructions for a computer. The set of instructions includes an image processing routine configured to process an image based on an automatically determined initial field of view for the image, and a user interface routine capable of adjusting the initial field of view to produce an adjusted field of view for the image. The user interface routine allows a series of locations and/or a boundary to be defined to form the adjusted field of view for the image. The image processing routine may process the image based on the adjusted field of view for the image. In an embodiment, the image processing routine and the user interface routine may execute iteratively until an adjusted field of view is approved. In an embodiment, the set of instructions includes a storage routine for storing the raw image and/or processed image, for example.

### BRIEF DESCRIPTION OF SEVERAL VIEWS OF THE DRAWINGS

FIG. 1 depicts a detector area containing an exposed image area.

FIG. 2 illustrates an imaging system used in accordance with an embodiment of the present invention.

FIG. 3 illustrates a flow diagram for a method for field of view adjustment used in accordance with an embodiment of the present invention.

FIG. 4 illustrates an example adjustment of the field of view for an image in accordance with an embodiment of the present invention.

FIG. 5 illustrates an image processing system capable of processing an image and adjusting an image's field of view in accordance with an embodiment of the present invention.

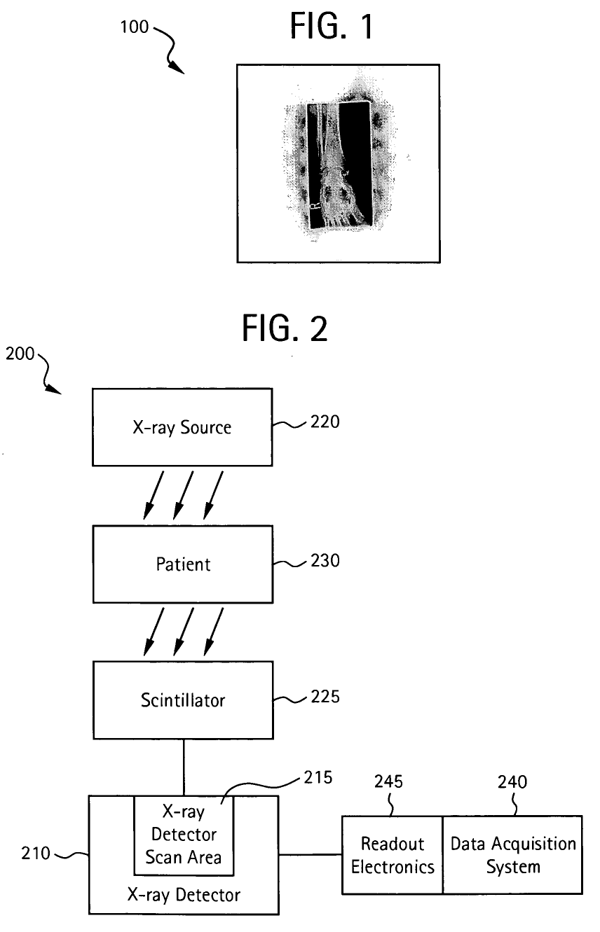

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

FIG. 2 illustrates an imaging system 200 used in accordance with an embodiment of the present invention. The imaging system 200 includes a plurality of subsystems. For the purposes of illustration, the imaging system 200 is described as an x-ray system. The imaging system 200 includes subsystems, such as an x-ray detector 210 including an array 215 of detector cells, an x-ray source 220, a scintillator 225, and an object 230. The imaging system 200 also includes a data acquisition system 240 with read out electronics 245. In an embodiment, the scintillator 225 comprises a screen positioned in front of the detector 210. In an embodiment, the detector 210 is an amorphous silicon flat panel detector. The object 230 may be a patient or another object to be imaged.

The object 230 is positioned in imaging system 200 for imaging. In one exemplary system, an x-ray source 220 is positioned above the object 230. The x-ray detector 210 is positioned below the object 230. The scintillator 225 is positioned between the object 230 and the x-ray detector 210. X-rays are transmitted from the x-ray source 220 through the object 230 to the scintillator 225. The scintillator 225 emits light in response to the x-rays transmitted from the x-ray source 220 through the object 230. The emitted light is transmitted to the x-ray detector 210 and the x-ray detector array 215. For example, light emitted by the scintillator 225 activates or discharges photodiodes in the detector array 215 to varying degrees. The read out electronics 245 may include a reference and regulation board (RRB) or other data collection unit. The RRB may accommodate and connect data modules to transfer data from the detector 210 to the data acquisition system 240. The read out electronics 245 transmit the data from the detector 210 to the data acquisition system 240. The data acquisition system 240 forms an image from the data and may store, display, and/or transmit the image. Preprocessing and processing functions may be applied to the acquired image before and/or after storage, display, and/or transmission, for example.

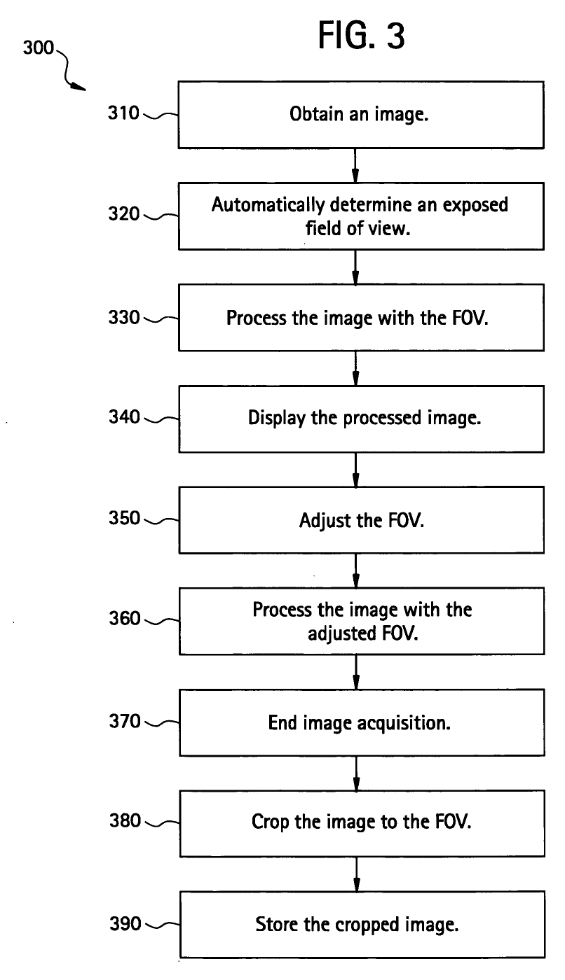

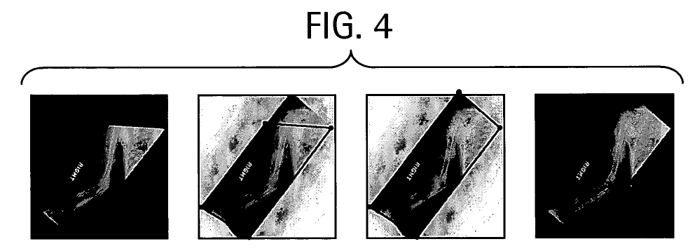

Certain embodiments provide a system and method by which a user, such as a radiologist or other healthcare practitioner, may interactively and efficiently adjust a field of view (FOV) for an imaging system, such as a digital radiography system, in order to limit the FOV to a clinically relevant (exposed) anatomy. FIG. 3 illustrates a flow diagram for a method 300 for FOV adjustment used in accordance with an embodiment of the present invention. First, at step 310, an image exposure is obtained using a detector, such as the detector 210. For example, a chest image exposure may be taken using a flat panel detector or computed radiography (CR) plate. Then, at step 320, an exposed FOV is automatically determined for the image read from the detector (i.e., the raw image). For example, the radiography system automatically determines the field of view for the chest image obtained from the detector.

At step 330, the image is processed using the automatically determined FOV. For example, the radiography system assumes that the automatically determined FOV is appropriate, and the image is processed and/or enhanced with respect to the FOV. The image may be processed using information extracted from the FOV, for example. Next, at step 340, the processed image is displayed. Information outside of or beyond the automatically determined FOV is shuttered or masked (e.g., a black mask), for example.

At step 350, the FOV may be adjusted. For example, a user, such as a radiology technologist, radiologist, physician or other healthcare practitioner, may view the image with the automatically determined FOV and decide to adjust the FOV. FIG. 4 illustrates an example adjustment of the FOV for an image. As shown in FIG. 4, a user may be shown a border representing the automatically determined FOV and then adjust that border to represent a desired FOV. A user may be presented with a variety of options to adjust the FOV. For example, a user may select a user interface button or other icon that removes the shutter or mask and displays an outline of the automatically determined FOV. The user may then position the FOV outline at desired location(s). For example, the user may use a mouse, touch screen or other pointing device to move the edge(s), vertice(s) and/or other series of points of the FOV outline to desired location(s). A user interface button or other icon may then be selected to accept changes to the FOV, for example. The new FOV for the image now corresponds to the FOV outline adjusted by the user.

Then, at step 360, image processing may be automatically re-applied to the image with the new FOV. The image may be re-processing using information extracted from the adjusted FOV, for example. The FOV outline is removed from the display and the shutter/mask is re-applied. Additionally, a user may manually request and/or apply additional processing functions to the image with the new FOV. In an embodiment, adjustment of the FOV and processing of the image may be repeated until the user is satisfied with the resultant image.

At step 370, the image acquisition or viewing is ended. At step 380, the image is cropped to the area (e.g., the rectangular area) bounding the user-defined FOV. Image information outside the FOV is shuttered or masked. Then, at step 390, the cropped image is stored. In an embodiment, the image may be stored, displayed and/or transmitted, for example.

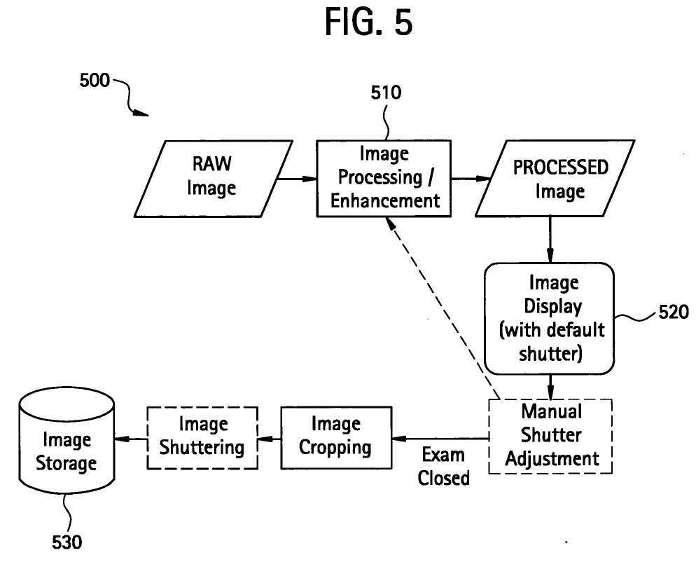

FIG. 5 illustrates an image processing system 500 capable of processing an image and adjusting an image's field of view in accordance with an embodiment of the present invention. The system 500 includes an image processor 510, a user interface 520 and a storage device 530. The components of the system 500 may be implemented in software, hardware and/or firmware, for example. The components of the system 500 may be implemented separately and/or integrated in various forms, for example.

The image processor 510 may be configured to process raw image data to generate a processed image. The image processor 510 automatically determines a field of view for the raw image data for use in generating the processed image. The processor 510 may apply pre-processing and/or processing functions to the image data. A variety of pre-processing and processing functions are known in the art. The image processor 510 may be used to process both a raw image and processed image with an adjusted FOV. The image processor 510 may process a raw image to generate a processed image and then re-process a processed image with an adjusted FOV. In an embodiment, the image processor is capable of retrieving raw image data to regenerate a processed image and automatically determine a FOV.

The user interface 520 may be configured to allow a user to adjust the field of view for the processed image. The user interface 520 may include a mouse-driven interface, a touch screen interface or other interface providing user-selectable options, for example. In an embodiment, the user interface 520 is used to select a series of points and/or a boundary or outline surrounding an area of the processed image. The points and/or boundary may be positioned to adjust the FOV of the image.

The storage device 530 is capable of storing images and other data. The storage device 530 may be a memory, a picture archiving and communication system, a radiology information system, hospital information system, an image library, an archive, and/or other data storage, for example. The storage device 530 may be used to store the raw image, the processed image with the automatically determined FOV, and the processed image with the adjusted FOV, for example. In an embodiment, a processed image may be stored in association with related raw image data.

In operation, the image processor 510 obtains image data from an image source, such as the storage device 530. The image processor 510 processes (and/or pre-processes) the image data assuming a default FOV. The image processor 510 then displays the processed image using the user interface 520. A user may view the image via the user interface 520 and execute functions with respect to the image, including saving the image, modifying the image, and/or adjusting the FOV, for example. Using the user interface 520, the user may place or adjust a series of points/vertices to form an FOV boundary on an image. Alternatively, the user may position or re-position a boundary placed around all or part of the image to adjust the FOV (see, e.g., FIG. 4).

After the FOV has been adjusted, the image processor 510 may re-process and/or further process the image data using the adjusted FOV. The image is masked and cropped using the adjusted FOV. After processing, the image may be stored in the storage device 530 and/or otherwise transmitted. FOV adjustment and processing may be repeated before and/or after storage of the image in the storage device 530.

In an embodiment, the processor 510 and interface 520 may be implemented as instructions on a computer-readable medium. For example, the instructions may include an image processing routine and a user interface routine. The image processing routine is configured to process an image based on information extracted from an automatically determined initial FOV for the image. The image processing routine generates a processed image from a raw image. The image processing routine is also configured to process the image based on information extracted from an adjusted FOV. The user interface routine is capable of adjusting the initial FOV to produce an adjusted FOV for the image. The user interface routine allows a series of locations and/or a boundary to be defined to form the adjusted field of view for the image, for example. In an embodiment, the image processing routine and the user interface routine execute iteratively until an adjusted field of view is approved by a user or software. A storage routine may be used to store the raw image in association with the processed image with the adjusted field of view.

Thus, certain embodiments enable a user of a digital radiography system or other imaging system to interactively and efficiently define a useful FOV of an acquired image. The image is then cropped to the user-defined FOV and stored. Certain embodiments provide a reduction in image storage space because clinically irrelevant image information is not saved. Certain embodiments improve recovery from system errors. Incorrect or inaccurate automatic determination of the exposed FOV by the system may be quickly corrected by the user. Certain embodiments provide enhanced image quality. Image processing algorithms apply only to the useful FOV and optimize the visualization of clinical details within the FOV.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for improved definition of a field of view for a digital radiography image, said method comprising:
retrieving image data for an image;
automatically determining a field of view for said image;
manually adjusting said field of view;
confirming said adjusted field of view; and
storing said image based on said adjusted field of view.

2. The method of claim 1, wherein said image data comprises a raw image before processing.

3. The method of claim 1, further comprising cropping said image based on said adjusted field of view.

4. The method of claim 1, further comprising processing said image data using said automatically determined field of view.

5. The method of claim 1, further comprising presenting said image to a user for manual adjustment of said field of view.

6. The method of claim 1, further comprising re-processing said image data using said adjusted field of view.

7. The method of claim 1, further comprising saving said image data with said adjusted field of view.

8. The method of claim 1, further comprising retrieving raw image data after said image data has been processed using said adjusted field of view and using said raw image data to re-determine and adjust said field of view.

9. The method of claim 1, wherein said step of manually adjusting further comprises defining a new field of view by selecting a series of points on the image.

10. The method of claim 1, wherein said step of manually adjusting further comprises selecting a boundary to define said field of view.

11. A system for improved adjustment of a field of view for an image, said system comprising:
an image processor configured to process raw image data to generate a processed image, wherein said image processor automatically determines a field of view for said raw image data for use in generating the processed image; and
a user interface configured to allow a user to adjust said field of view for said processed image,
wherein said image processor crops said processed image based on said adjusted field of view.

12. The system of claim 11, wherein said user interface comprises at least one of a mouse-driven interface and a touch screen interface configured to allow said user to adjust said field of view.

13. The system of claim 11, wherein said user interface is used to select at least one of a series of points and a boundary to adjust said field of view.

14. The system of claim 11, wherein said image processor re-processes said processed image with said adjusted field of view.

15. The system of claim 11, wherein said image processor is capable of retrieving said raw image data to regenerate said processed image and automatically determine said field of view.

16. The system of claim 11, further comprising a storage device for storing said processed image with said adjusted field of view.

17. The system of claim 16, wherein said storage device stores said processed image with said adjusted field of view and said raw image data, wherein said processed image data is stored in association with said raw image.

18. A computer-readable storage medium including a set of instructions for a computer, the set of instructions comprising:
an image processing routine configured to process an image based on an automatically determined initial field of view for the image; and
a user interface routine capable of adjusting the initial field of view to produce an adjusted field of view for the image, wherein said user interface routine allows at least one of a series of locations and a boundary to be defined to form the adjusted field of view for the image.

19. The set of instructions of claim 18, wherein said image processing routine and said user interface routine execute iteratively until an adjusted field of view is approved.

20. The set of instructions of claim 18, wherein said image processing routine processes the image based on the adjusted field of view for the image.

21. The set of instructions of claim 18, wherein said image processing routine generates a processed image from a raw image, and further comprising a storage routine for storing the raw image in association with the processed image with the refined field of view.
